(19) United States
(12) Patent Application Publication
(10) Pub. No.: US 2007/0107631 A1
(43) Pub. Date: May 17, 2007

(54) Covers including a shaped surface

(75) Inventors: John Michael Vasarhelyi, Cary, NC (US); Louis F. Teran, Granada Hills, CA (US); David Scott DeVerter, Raleigh, NC (US)

Correspondence Address: PEARNE & GORDON LLP, 1801 EAST 9TH STREET, SUITE 1200, CLEVELAND, OH, 44114-3108, US

(73) Assignee: Pentair Water Pool and Spa, Inc., Moorpark, CA (US)

(21) Appl. No.: 11/399,043

(22) Filed: Apr. 6, 2006

Related U.S. Application Data
(60) Provisional application No. 60/731,815, filed on Oct. 31, 2005.

(51) Int. Cl. B01F 17/00

(52) U.S. Cl. 106/287.24; 524/291

(57) ABSTRACT

Covers for a container including an interior area are provided. The covers include a shaped surface for facing away from an interior area of a container. Example covers can include a substantially planar surface, a substantially concave surface, and a smooth transition from the substantially planar surface to the substantially concave surface. Further examples of covers can include a first substantially convex surface, a second substantially convex surface, and a substantially concave surface. Still further examples of covers can include a second surface for facing towards an interior area of the container wherein the second surface includes a transition that substantially follows a transition of the shaped surface.

### CROSS-REFERENCE TO RELATED APPLICATION

The present invention claims the benefit of U.S. Provisional Application No. 60/731,815 filed Oct. 31, 2005, the entire disclosure which is herein incorporated by reference.

### FIELD OF THE INVENTION

The present invention relates to covers, and more particular to covers including a shaped surface for facing away from an interior area of a container.

### BACKGROUND OF THE INVENTION

Conventional housings are known to include a cover. The housing typically forms an interior area and the cover is configured to cooperate with another structure of the housing to close the interior area. Such covers are known to include an outer surface with a substantially flat upper surface. Such flat surfaces may not be designed to encourage fluid flow in a particular direction. Still further, a certain amount of fluid may pool on the upper flat surface of the cover.

### SUMMARY OF THE INVENTION

Accordingly, it is an aspect of the present invention to obviate problems and shortcomings of conventional covers.

In accordance with one aspect, a cover for a container including an interior area is provided. The cover includes a shaped surface for facing away from an interior area of a container. The shaped surface includes a substantially planar surface, a substantially concave surface, and a smooth transition from the substantially planar surface to the substantially concave surface.

In accordance with another aspect, a cover for a container including an interior area is provided. The cover includes a shaped surface for facing away from an interior area of a container. The shaped surface includes a first substantially convex surface, a second substantially convex surface, and a substantially concave surface. A portion of the substantially concave surface extends from a portion of the first convex surface to a portion of the second convex surface.

In accordance with still another aspect, a cover for a container including an interior area is provided. The cover includes a shaped surface for facing away from an interior area of a container. The shaped surface includes a first substantially convex surface, a second substantially convex surface, a substantially planar surface, a substantially concave surface, and a transition from the substantially planar surface to the substantially concave surface. The cover further includes a second surface for facing towards an interior area of a container. The second surface includes a transition that substantially follows the transition of the shaped surface.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a perspective view of a junction box incorporating aspects of the present invention;

FIG. 2 is a top view of the junction box of FIG. 1;

FIG. 3 is a top view of the junction box of FIG. 1 with the cover in an open orientation;

FIG. 4 is a sectional view of the junction box along line 4-4 of FIG. 2;

FIG. 5 is a front elevational view of the junction box of FIG. 1;

FIG. 6 is a front elevational view of the junction box of FIG. 1 with the cover in an open orientation;

FIG. 7 is a right side elevational view of the junction box of FIG. 1;

FIG. 8 is a right side elevational view of the junction box of FIG. 1 with the cover in an open orientation; and

FIG. 9 is a bottom view of the junction box of FIG. 1.

### DETAILED DESCRIPTION OF EXAMPLE EMBODIMENTS

Certain terminology is used herein for convenience only and is not to be taken as a limitation on the present invention. Further, in the drawings, the same reference numerals are employed for designating the same elements.

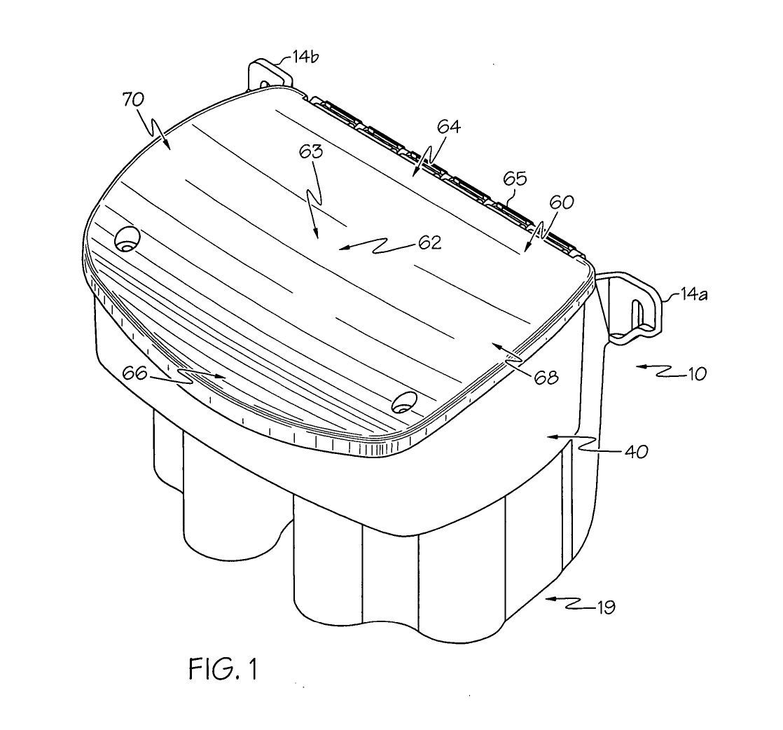

Aspects of the present invention comprise covers for use with a container including an interior area for receiving electrical wire from a conduit. FIGS. 1-8 depict a cover 60 in accordance with one example of the present invention. The example cover may be incorporated as part of a housing. FIGS. 1-9 depict one example of a housing 10 including a container 40 defining an interior area 42 of the housing 10. The container 40 can include a peripheral edge 44 defining an opening 43 providing access into the interior area 42. The cover 60 of the housing is configured to close the opening 43 into the interior area 42.

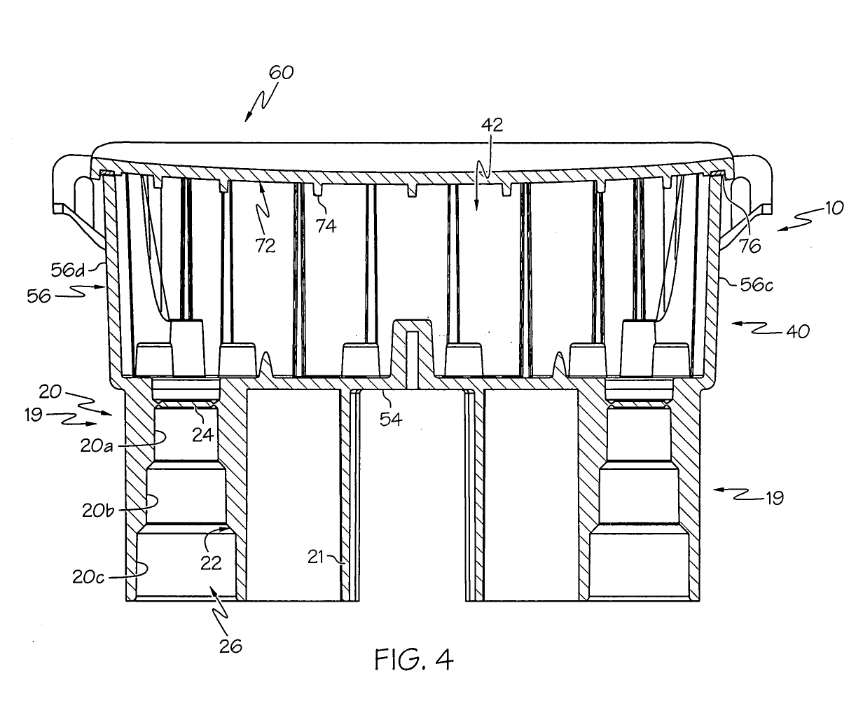

The container 40 can comprise various structural configurations to define the interior area 42. For example, as shown, the container 40 can include a base wall 54 and a peripheral wall 56 including the peripheral edge 44. The base wall 54 is illustrated as substantially planar but may comprise, at least partially or entirely, a curved or other nonplanar shape. The peripheral wall 56 can be disposed to extend from the base wall 54 at a wide range of angles. For example, as shown in FIG. 4, the peripheral wall 56 can extend at an angle of slightly greater than 90° from the base wall to simplify injection molding techniques. In further examples, the base wall can extend at 90° from the base wall 54 or at various angles greater or less than 90° from the base wall 54. As further illustrated, the peripheral wall 56 can at least partially circumscribe the interior area 42. In the illustrated example, the peripheral wall 56 entirely circumscribes the interior area 42 of the container 40.

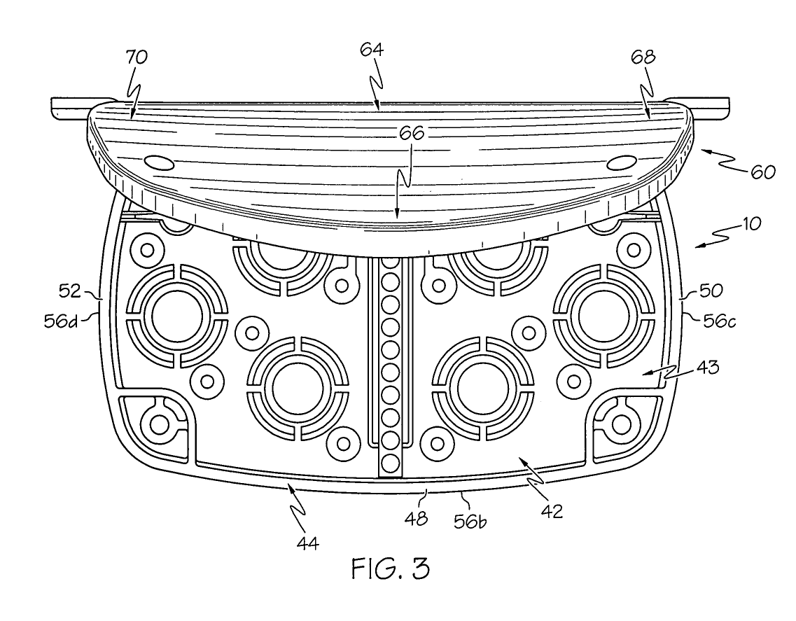

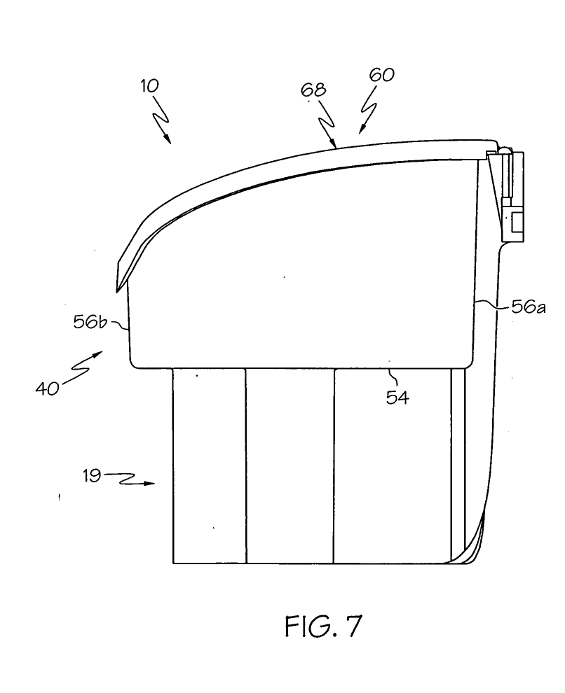

The peripheral wall 56 can have a single wall portion or a plurality of wall portions. For example, the peripheral wall can comprise a single wall portion having a circular, oval, or other shape. In further examples, the peripheral wall can comprise a plurality of wall portions defining a generally polygonal shape having three or more sides. For instance, the peripheral wall can comprise three or more wall portions connected with respect to one another to form a peripheral wall including a substantially triangular, rectangular, square, or other polygonal shape. Moreover, each wall portion can include one or more different types of segments. For instance one or more wall portions can be formed with a substantially straight segment defining a substantially planar surface. In further examples, one or more wall portions can be formed with a substantially curved segment having a substantially curved surface. For example, as shown in FIGS. 3 and 7, the illustrated peripheral wall 56 comprises four wall portions defining a generally rectangular shape. The illustrated generally rectangular peripheral wall 56 includes a first wall portion 56a, a second wall portion 56b, a third wall portion 56c and a fourth wall portion 56d. Although not required, the first wall portion 56a comprises a substantially straight segment (see FIG. 7) while the second, third and fourth wall portions 56b, 56c, 56d comprise substantially curved segments (see FIG. 3).

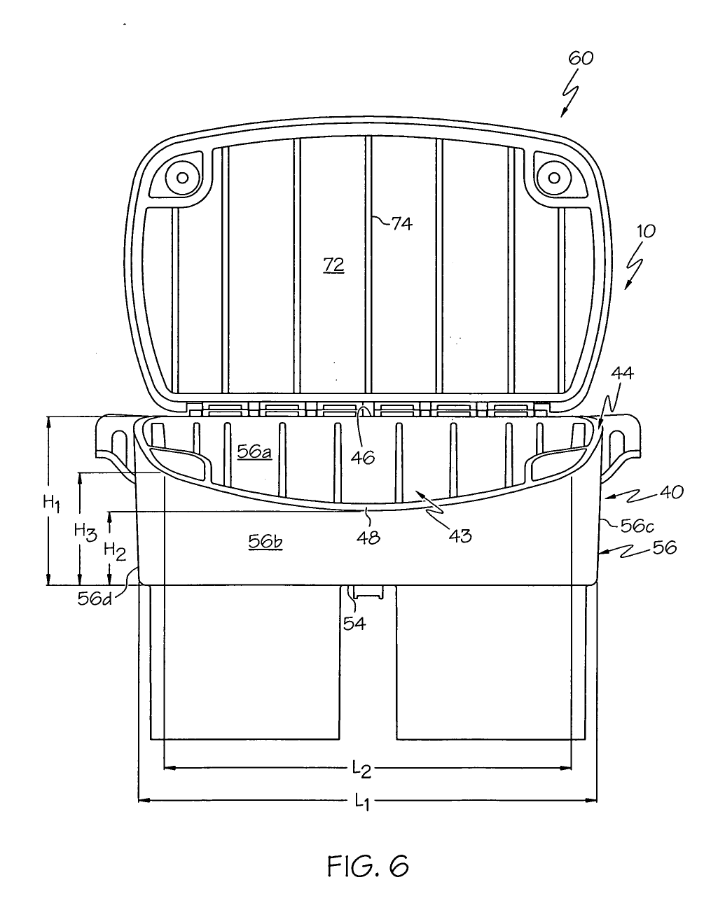

Each wall portion can extend at various heights with respect to the base wall. For example, each wall portion can extend from the base wall with substantially the same height profile. In further examples, at least one wall portion can extend from the base wall with a height profile that is substantially different than a height profile of another wall portion. One or more of the wall portions may have a height profile comprising a substantially straight line that is substantially parallel to the base wall wherein the height of the wall portion is substantially constant along a length of the wall portion. For instance, as shown in FIG. 6, the first wall portion 56a has a height profile comprising a substantially straight line that is substantially parallel to the base wall 54 wherein the first wall portion 56a extends from the base 54 at a substantially constant first height “H₁” along the entire length “L₁” of the first wall portion 56a. Providing the first wall portion 56a with a height profile comprising a substantially straight line can accommodate a linear hinge as described below.

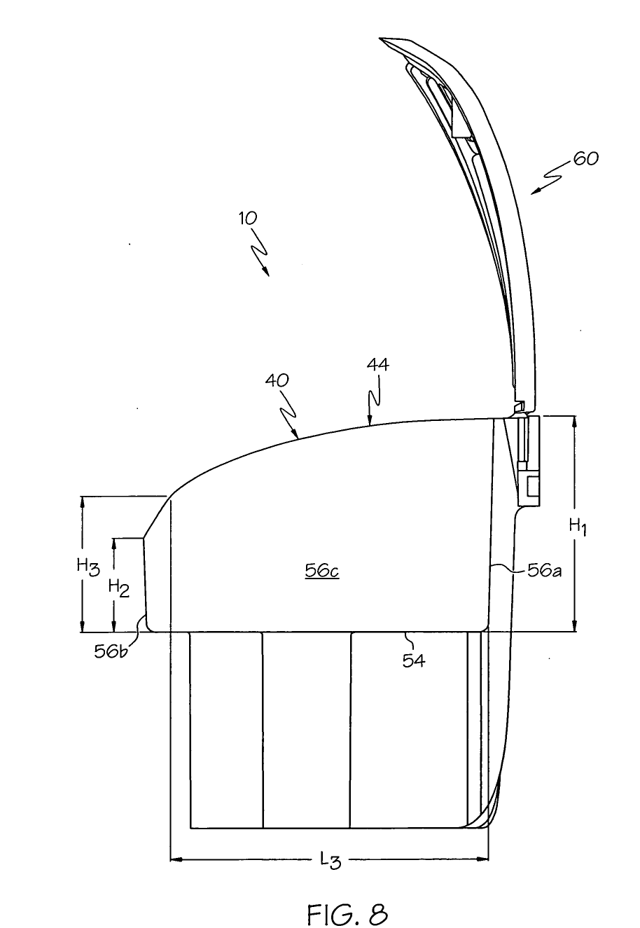

In further examples, one or more of the wall portions may have a height profile comprising a substantially straight line that extends at an angle with respect to the base wall wherein the height of the wall portion changes along a length of the wall portion. In still further examples, one or more wall portions may have a height profile comprising a curved line wherein the height of the wall portion changes along a length of the wall portion. For example, as shown in FIG. 6, the second wall portion 56b includes a height profile comprising a curved line that extends from the base 54 at a height that changes along the entire length “L₂” of the second wall portion 56b between a second height “H₂” to a third height “H₃”. As shown in FIGS. 3 and 6, the third and fourth wall portions 56c, 56d can be substantially identical mirror images of one another. Moreover, as shown in FIG. 8, the third and fourth wall portions 56c, 56d each have a height profile comprising a curved line that extends from the base 54 at a height that changes along the entire length “L₃” of the third and fourth wall portions 56c, 56d between the first height “H₁” to the third height “H₃”. The height profiles of the wall portions permit the peripheral edge 44 of the peripheral wall 56 to conform to the shape of corresponding portions of the cover 60. Morever, as shown in FIG. 7, the height profiles of the wall portions further permit the cover 60 to generally extend at an angle with respect to the base wall 54 in the closed position by extending from the first wall portion 56a to the second wall portion 56b.

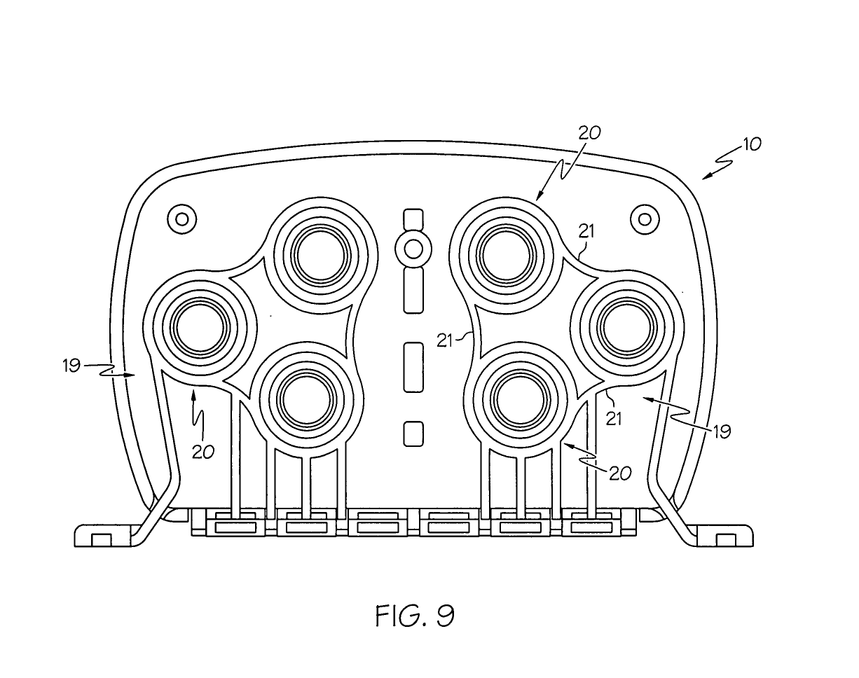

As shown, housings can comprise at least one coupling although further examples of the invention may be employed without couplings. Each coupling, if provided, includes an internal passage configured for communicating with an interior area of the housing. The internal passage permits wires from a conduit to be inserted through the internal passage and into the interior area of the housing. For example, as shown in FIG. 9, one example of the at least one coupling comprises a six sockets 20 although more or less than six sockets may be employed in further examples. Each socket 20 includes an internal passage 26 configured to communicate with an interior area 42 of the housing 10. Each socket 20 can also include an optional knock-out wall 24 adapted to initially inhibit a communication between the interior area 42 of the housing 10 and the internal passage 26 of the socket 20.

As shown in FIG. 4, each socket 20 can comprise three reception areas 20a, 20b, 20c that successively increase in size along the internal passage 26 to form a stepped configuration to alternatively receive conduits having three different sizes. The stepped configuration of the attachment areas of the coupling can be formed with a wide range of sizes and configurations to accommodate alternative conduit sizes and/or shapes. For example, the first reception area 20a may be dimensioned to receive a 0.5 inch conduit, the second reception area 20b may be dimensioned to receive a 0.75 inch conduit, and the third reception area 20c may be configured to receive a 1 inch conduit. In alternative embodiments, the sockets may be able to receive conduits having other dimensions. Accordingly, a single socket may be provided with reception areas arranged in a stepped configuration to accommodate one of various standard and/or customized conduit sizes. An optional chamfered surface 22 may be provided between adjacent reception areas to help the end of a smaller conduit travel from a larger sized reception area to a smaller sized reception area when inserting a conduit into the socket.

The reception areas can also include a wide variety of shapes to accommodate various applications. As shown in the illustrated example, the reception areas 20a, 20b, 20c can comprise a substantially circular cylindrical cross sectional shape. In such an embodiment, the plurality of reception areas include successively larger inner diameters along the internal passage such that the socket forms a stepped configuration to receive and attach to an outer cylindrical area of different sized conduits.

Aspects of the present invention may include a single coupling although a plurality of couplings may be provided in further examples. For instance, as shown in FIG. 9, six sockets 20 are provided although more or less sockets may be provided in further examples. If a plurality of sockets are provided, they may be independently supported with respect to a portion of the container. Alternatively, a plurality of the sockets may be linked together. For instance, as illustrated, a plurality of the sockets may be linked together with walls 21 as one or more clusters 19 to increase the overall structural integrity of the sockets 20.

Housings in accordance with the present invention may be constructed in a wide variety of ways and from a wide range of materials, such as weather resistant materials. For instance, components of the housings may be constructed from metal, plastic, composites, resins, and/or other materials. In one example, components of the housing are formed with an injection molding process although other fabrication techniques may be employed. As shown, the container and the couplings may be integrally molded, such as injection molded, as a one piece design to simplify the manufacturing process and to enhance the structural integrity of the couplings. For example, as shown in FIG. 4, each coupling 20 can be integrally molded with the base wall 54.

As mentioned previously, housings in accordance with the present invention include a cover to close the opening into the interior area defined by the container. Aspects of the present invention may be used with various cover types and configurations. In one example, the cover can be designed to selectively close the container although it is contemplated that the cover may also be designed to permanently close the interior area of the housing. A variety of cover configurations may be provided to allow the cover to selectively close a container. For example, the cover may be designed for complete disengagement from the housing to open the interior area of the container. In such an embodiment, the cover may snap into place to discourage inadvertent removal of the cover from the container.

In further examples, the cover can be pivotally connected to the container wherein the cover can pivot between closed and open orientations. For instance, as shown in the illustrated example, the cover 60 can be pivotally attached to the container 40 by way of a hinge structure 65. As shown in FIGS. 1, 2, 5 and 7, the cover may be pivoted to a closed orientation wherein the cover closes the opening 43 of the container 40. Alternatively, as shown in FIGS. 3, 6 and 8, the cover 60 can also be pivoted to an open orientation wherein the cover does not close the opening 43 of the container 40.

Various structures may be provided to pivotally connect the cover to the container. For example, a living hinge may be provided between the cover and the container. In further examples, the cover and container can include hinge portions that cooperate to define the hinge structure. As shown, portions of the cover 60 and the container 40 cooperate to form a hinge structure 65 to pivotally attach the cover 60 to the container 40. As shown, the hinge structure 65 comprises a linear hinge structure although nonlinear hinge structures may be provided in further examples of the present invention.

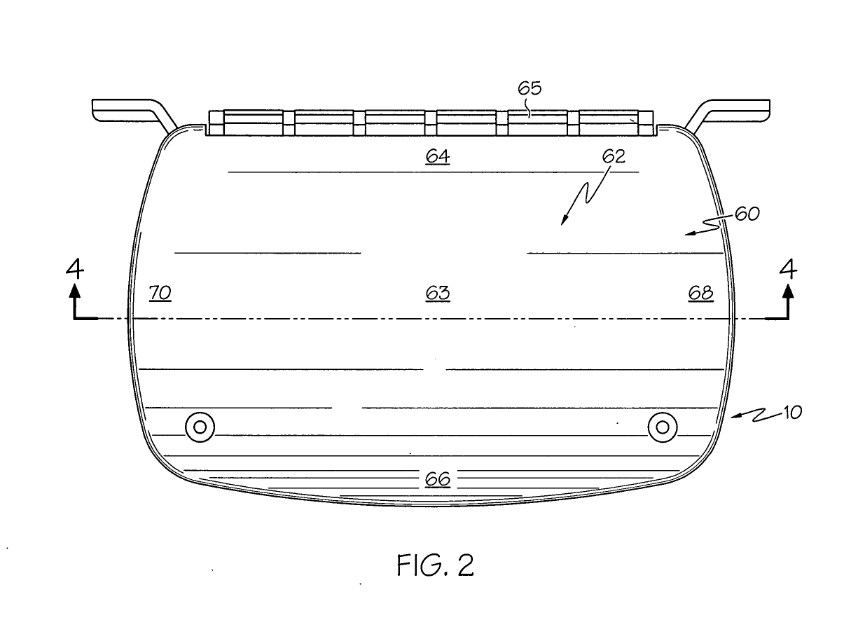

The cover can include a wide variety of shapes and sizes. Covers in accordance with the present invention comprise a shaped surface 62 for facing away from the interior area 42 of the container 40. In one example, the shaped surface 62 can include a substantially planar surface 64. Providing the substantially planar surface 64 can be beneficial to accommodate a linear hinge structure. Indeed, as shown in FIGS. 1 and 2, the substantially planar surface 64 provides a linear area configured to accommodate a linear hinge structure 65. In further examples, it is also contemplated that a nonplanar surface may be provided that can accommodate a linear hinge structure. However, the illustrated planar surface 64 may be provided to minimize the thickness of the cover 60 while providing sufficient mounting for the linear hinge structure. In still further examples, it is contemplated that a nonlinear hinge structure may be incorporated with a nonplanar or substantially planar surface.

As further illustrated, the shaped surface 62 of the cover can also include a substantially concave surface 66 to help direct a liquid flowing on the shaped surface 62. The substantially concave surface 66 can be located at various positions of the shaped surface 62. In the illustrated example, the substantially concave surface 66 is opposed to the substantially planar surface 64 at the front portion of the cover 60. Providing the substantially concave surface 66 at the front portion of the cover 60 can help direct a liquid flow stream in a direction from the rear portion to the front portion of the cover 60. Moreover, providing the substantially concave surface 66 at the front of the cover 60 can be used with a second wall portion 56b having a reduced height “H₂”. As shown in FIG. 6, providing the second wall portion 56b with a reduced height “H₂” can provide enhanced access into the interior area 42 by an individual accessing the interior area 42 of the container 40 from the front side of the container.

If the concave surface 66 is provided at the front portion of the cover 60, the substantially concave surface may be located at a right, left, or central area of the front portion of the cover 60. For example, as shown, the substantially concave surface 66 is located at a central area of the front portion of the cover 60. Thus as shown, a liquid flow on the shaped surface 62 may be encouraged to flow from the rear portion of the cover 60 toward the central area of the front portion of the cover 60. Moreover, providing the substantially concave surface 66 at the central area of the front cover 60 can be used with a second wall portion 56b having a reduced height “H₂” located at a central portion of the second wall portion 56b. As shown in FIG. 6, providing the reduced height “H₂” at the central portion of the second wall portion 56b can allow enhanced access to central portions of the interior area 42 while still allowing sufficient access to the right and left areas of the interior area 42 of the container 40.

As further illustrated, examples of the shaped surface 62 can also include a smooth transition 63 from the substantially planar surface 64 to the substantially concave surface 66. Providing a smooth transition 63 can be beneficial to help prevent pooling of liquid on the cover. Rather than pooling, a liquid stream can be directed along the cover 60 to gradually transition between areas of the shaped surface 62.

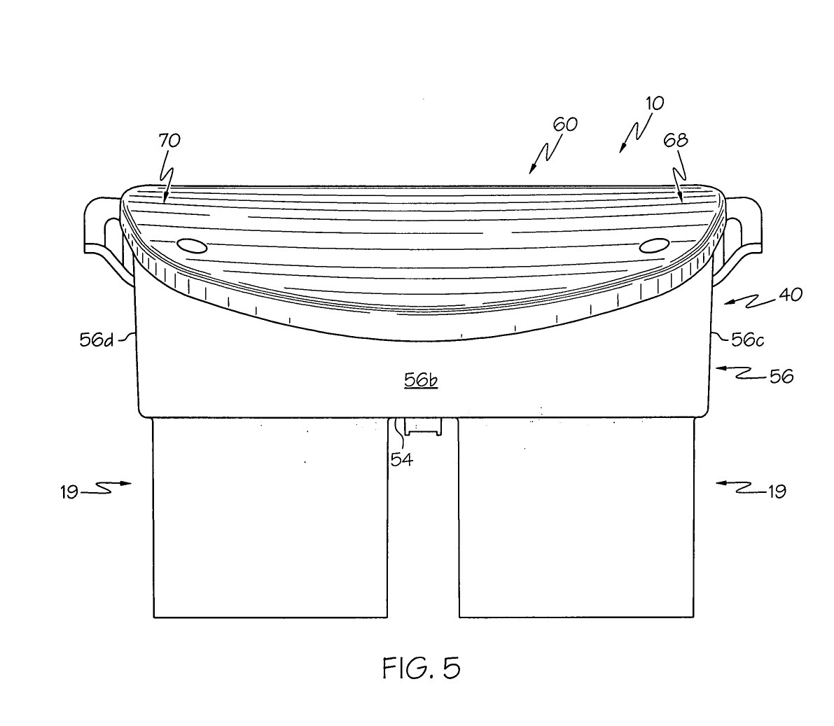

Examples of the shaped surface may include at least one convex surface. For example, as shown, the shaped surface 62 can comprise a first substantially convex surface 68 and a second substantially convex surface 70. As shown in FIG. 5, the convex surfaces 68 and 70 can comprise substantial mirror images of one another. The convex surfaces can further enhance drainage of liquid from the cover. For example, as shown in profile in FIG. 7, the convex surface 68 can extend downward from a rear of the shaped surface 62 towards a front of the shaped surface 62. Moreover, providing the substantially convex surfaces 68 and 70 at the right and left portions of the cover 60 can be used with third and fourth wall portions 56c, 56d of a container 40 having an increased height “H₁” at the rear of the container that gradually reduces to the maximum height “H₃” of the second wall portion 56b in a direction towards the front of the container. Therefore, the height of the third and fourth wall portion 56c, 56d can be increased to provide a larger interior area 42 for the container 40 while still providing convex surfaces 68 and 70 to enhance drainage of liquid from the cover 60.

As shown in FIGS. 1 and 3, a portion of the substantially concave surface 66 extends from a portion of the first convex surface 68 to a portion of the second convex surface 70. Indeed, the illustrated shaped surface 62 gradually transitions from the substantially planar surface 64 to the substantially concave surface 66. As the concave surface 66 begins to form in a direction from the rear portion to the front portion of the cover 60, portions of the concave surface 66 extend between portions of the first and second convex surfaces 68. Furthermore, as shown in FIG. 2, portions of the concave surface 66 farthest away from the substantially planar surface 64 extend beyond surface areas located between the convex surfaces 68, 70. Although not shown, in further examples, the concave surface may be located entirely between the convex surfaces.

Accordingly, covers herein can shield the interior area of the container from contaminants such as liquids. For example, the cover can be configured to shield the interior area from water originating from a body of water, such as a swimming pool, hot tub, or the like. The cover is can also shield the interior area from water originating from a garden hose, rain, or other condensation. Moreover, providing the cover with the illustrated and described shaped surface 62 can accommodate a linear hinge structure while encouraging drainage of fluid introduced to the surface of the cover. Indeed, the substantially planar surface 64 is configured to accommodate the illustrated linear hinge structure 65. Moreover, the substantially concave surface 66 and the substantially convex surfaces 68, 70 can help direct a drainage flow of liquid introduced to the shaped surface 62. Indeed, the concave surface 66 and convex surfaces 68, 70 can generally encourage liquid to drain in a direction from the substantially planar surface 64 at the rear of the housing towards the substantially concave surface 66 at the front of the housing.

As shown in FIGS. 4 and 6, the cover 60 can also include a second surface 72 for facing towards the interior area 42 of the container 40, wherein the second surface includes a transition that substantially follows the transition 63 of the shaped surface 62. Providing the second surface 72 that substantially follows the transition 63 of the shaped surface 62 can provide a substantially constant or desired thickness of material to enhance the structural integrity of the cover without excess material. As shown, the second surface 72 can be provided with a plurality of ribs 74 adapted to increase the rigidity of the cover 60.

The peripheral edge 44 of the container 40 can also be designed to follow the shape of the cover. For example, as shown in FIGS. 3 and 6, the peripheral edge 44 can include a substantially straight portion 46 configured to extend with respect to the substantially planar surface 64 of the cover 60 and a substantially curved portion 48 configured to extend with respect to the substantially concave surface 66 of the cover 60. The peripheral edge 44 can also include a substantially curved portion 50 configured to extend with respect to the first substantially convex surface 68 and another substantially curved portion 52 configured to extend with respect to the second substantially convex surface 70. The cover 60 can be designed to conform to the peripheral edge 44 of the peripheral wall 56 to encourage a fluid seal between the cover 60 and the housing 40. For instance, as shown in FIG. 4, the cover 60 can include a groove provided with a seal 76, such as a resilient gasket. When closing the housing 40 with the cover 60, the peripheral edge 44 may enter the groove of the cover 60 and engage the seal 76 to provide a fluid seal between the cover 60 and the container 40.

The housing 10 may be supported in a wide variety of ways. For example, the housing may be supported entirely by one or more conduits. Thus, the one or more sockets 20 may have sufficient structural integrity to allow the housing 10 to be entirely supported by the one or more conduits attached to the corresponding one or more sockets 20. In addition or alternatively, one or more mounting tabs may be provided to allow the housing to be mounted to a support surface. For instance, as shown in FIG. 1, a pair of mounting tabs 14a, 14b are provided to allow the housing 10 to be mounted to a vertical wall or other surface. Although not shown, a separate mounting adapter may also be provided to permit connection between the housing and a post having a circular cross section.

From the above description of the invention, those skilled in the art will perceive improvements, changes and modifications. Such improvements, changes and modifications within the skill of the art are intended to be covered by the appended claims.

What is claimed:

1. A cover for a container including an interior area comprising:
a shaped surface for facing away from an interior area of a container, the shaped surface including a substantially planar surface, a substantially concave surface, and a smooth transition from the substantially planar surface to the substantially concave surface.

2. The cover of claim 1, wherein the substantially planar surface is provided with a hinge structure adapted to pivotally connect the cover to a container.

3. A housing comprising a container and the cover of claim 1, the container comprising an interior area and a peripheral edge defining an opening, wherein the cover is configured to selectively close the opening of the container.

4. The housing of claim 3, wherein the peripheral edge comprises a substantially straight portion configured to extend with respect to the substantially planar surface of the cover and a substantially curved portion configured to extend with respect to the substantially concave surface of the cover.

5. The housing of claim 3, wherein the cover is pivotally connected to the container.

6. The housing of claim 3, wherein the container includes a base wall and a peripheral wall including the peripheral edge, wherein the peripheral wall extends from the base wall and circumscribes the interior area of the container, the peripheral wall includes a first wall portion and a second wall portion opposed to the first wall portion, the first wall portion extends from the base wall a first height and the second wall portion extends from the base wall a second height that is less than the first height, and wherein the cover is configured to extend at an angle with respect to the base wall in the closed position by extending from the first wall portion towards the second wall portion.

7. The housing of claim 6, wherein the peripheral edge comprises a substantially straight portion configured to extend with respect to the substantially planar surface of the cover and a substantially curved portion configured to extend with respect to the substantially concave surface of the cover, the first wall portion includes the substantially straight portion of the peripheral edge and the second wall portion includes the substantially curved portion of the peripheral edge, and wherein the cover is configured to extend at an angle with respect to the base wall in the closed position by extending from the substantially straight portion of the peripheral edge towards the substantially curved portion of the peripheral edge.

8. The cover of claim 1, wherein the shaped surface further includes a first substantially convex surface and a second substantially convex surface.

9. The cover of claim 8, wherein a portion of the substantially concave surface extends from a portion of the first convex surface to a portion of the second convex surface.

10. A housing comprising a container and the cover of claim 8, the container comprising an interior area and a peripheral edge defining an opening, wherein the cover is configured to selectively close the opening of the container.

11. The housing of claim 10, wherein the peripheral edge comprises a substantially straight portion configured to extend with respect to the substantially planar surface, a first substantially curved portion configured to extend with respect to the first substantially convex surface, a second substantially curved portion configured to extend with respect to the second substantially convex surface, and a third substantially curved portion configured to extend with respect to the substantially concave surface.

12. The housing of claim 10, wherein the container includes a base wall and a peripheral wall including the peripheral edge, wherein the peripheral wall extends from the base wall and circumscribes the interior area of the container, the peripheral wall includes a first wall portion and a second wall portion opposed to the first wall portion, the first wall portion extends from the base wall a first height and the second wall portion extends from the base wall a second height that is less than the first height, and wherein the cover is configured to extend at an angle with respect to the base wall in the closed position by extending from the first wall portion towards the second wall portion.

13. A cover for a container including an interior area comprising:
a shaped surface for facing away from an interior area of a container, the shaped surface including a first substantially convex surface, a second substantially convex surface, and a substantially concave surface, wherein a portion of the substantially concave surface extends from a portion of the first convex surface to a portion of the second convex surface.

14. A housing comprising a container and the cover of claim 13, the container comprising an interior area and a peripheral edge defining an opening, wherein the cover is configured to selectively close the opening of the container.

15. The housing of claim 14, wherein the peripheral edge comprises a first substantially curved portion configured to extend with respect to the first substantially convex surface, a second substantially curved portion configured to extend with respect to the second substantially convex surface, and a third substantially curved portion configured to extend with respect to the substantially concave surface.

16. The housing of claim 14, wherein the container includes a base wall and a peripheral wall including the peripheral edge, wherein the peripheral wall extends from the base wall and circumscribes the interior area of the container, the peripheral wall includes a first wall portion and a second wall portion opposed to the first wall portion, the first wall portion extends from the base wall a first height and the second wall portion extends from the base wall a second height that is less than the first height, and wherein the cover is configured to extend at an angle with respect to the base wall in the closed position by extending from the first wall portion towards the second wall portion.

17. A cover for a container including an interior area comprising:
a shaped surface for facing away from an interior area of a container, the shaped surface including a first substantially convex surface, a second substantially convex surface, a substantially planar surface, a substantially concave surface, and a transition from the substantially planar surface to the substantially concave surface; and
a second surface for facing towards an interior area of a container, wherein the second surface includes a transition that substantially follows the transition of the shaped surface.

18. The cover of claim 17, wherein the second surface is provided with a plurality of ribs adapted to increase the rigidity of the cover.

19. A housing comprising a container and the cover of claim 17, the container comprising an interior area and a peripheral edge defining an opening, wherein the cover is configured to selectively close the opening of the container.

20. The housing of claim 19, wherein the peripheral edge comprises substantially straight portion configured to extend with respect to the substantially planar surface, a first substantially curved portion configured to extend with respect to the first substantially convex surface, a second substantially curved portion configured to extend with respect to the second substantially convex surface, and a third substantially curved portion configured to extend with respect to the substantially concave surface.
